(19) United States
(12) Patent Application Publication
(10) Pub. No.: US 2015/0330539 A1
(43) Pub. Date: Nov. 19, 2015

(54) Tubular Member and Method and Apparatus For Producing a Tubular Member

(71) Applicant: Tyco Electronics Raychem GmbH, Ottobrunn (DE)

(72) Inventors: Thilo Simonsohn, Munich (DE); Christian Heindl, Munich (DE); Bernd Graeve, Neubiberg (DE)

(73) Assignee: TYCO ELECTRONICS RAYCHEM GMBH, Ottobrunn (DE)

(21) Appl. No.: 14/812,180

(22) Filed: Jul. 29, 2015

Related U.S. Application Data
(63) Continuation of application No. PCT/EP2013/051767, filed on Jan. 30, 2013.

(51) Int. Cl. F16L 11/16; F16L 11/24

(52) U.S. Cl. CPC F16L 11/16; F16L 11/24

(57) ABSTRACT

A method for producing a tubular member is provide and includes the following steps: extruding a first strand having a first side and a second side with an extrusion die, arranging the first strand into a plurality of helical windings, and bonding the first side and the second side.

### CROSS-REFERENCE TO RELATED APPLICATION

This application is a continuation of PCT International Patent Application No. PCT/EP2013/051767 filed Jan. 30, 2013.

### FIELD OF THE INVENTION

The invention relates to a tubular member and, more particularly, to a tubular member for a shrinkable tube.

### BACKGROUND

A holdout is a tubular member that serves to maintain the structure of a heat shrinkable tube in an expanded state. The shrinkable tube may for example include a heat-shrinking material or a cold-shrinking material. In order to shrink the shrinkable tube, the holdout is gradually removed by unwinding the holdout along a weak line arranged in spiral windings.

Known holdouts are typically made by bonding a strand of material in spiral windings. The strand is extruded in a first processing step and spooled onto a coiler. In a later second processing step, the strand is bonded in spiral windings to form the holdout. In an alternative production method known to the art, a holdout is formed as a continuous tubular member in a first production step. In a second production step, weak lines are cut into the tubular member along spiral windings using a turning machine. In the state of the art, holdouts are joined with shrinkable tubular members in a later manufacturing step.

### SUMMARY

It is an object of the present invention to provide a method for producing a tubular member.

The method for producing a tubular member includes the following steps: extruding a first strand having a first side and a second side with an extrusion die, arranging the first strand into a plurality of helical windings, and bonding the first side and the second side.

### BRIEF DESCRIPTION OF THE DRAWINGS

The invention will now be explained in more detail with reference to the Figures, in which:

FIG. 1 is a front view of a strand for a tubular member according to the invention;

FIG. 2 is a front view of two strands arranged in alternating helical windings for a tubular member according to the invention;

FIG. 3 is a front view of a tubular member according to the invention;

FIG. 4 is schematic diagram of a tubular member according to the invention prepared from a combined extrusion and bonding method;

FIG. 5 is a schematic diagram of a first apparatus for producing a tubular member according to the invention;

FIG. 6 is a schematic diagram of a second apparatus for producing a tubular member according to the invention;

FIG. 7 is a schematic diagram of a third apparatus for producing a tubular member according to the invention;

FIG. 8 is a schematic diagram of a fourth apparatus for producing a tubular member according to the invention;

FIG. 9 is a schematic diagram of a fifth apparatus for producing a tubular member according to the invention;

FIG. 10 is a schematic diagram of a first strand profile for a tubular member according to the invention;

FIG. 11 is a schematic diagram of a second strand profile for a tubular member according to the invention;

FIG. 12 is a schematic diagram of a third strand profile for a tubular member according to the invention;

FIG. 13 is a schematic diagram of a fourth strand profile for a tubular member according to the invention;

FIG. 14 is a schematic diagram of a fifth strand profile for a tubular member according to the invention; and

FIG. 15 is a schematic diagram of a sixth strand profile for a tubular member according to the invention.

### DETAILED DESCRIPTION OF THE EMBODIMENT(S)

The invention will now be described in more detail with reference to the Figures.

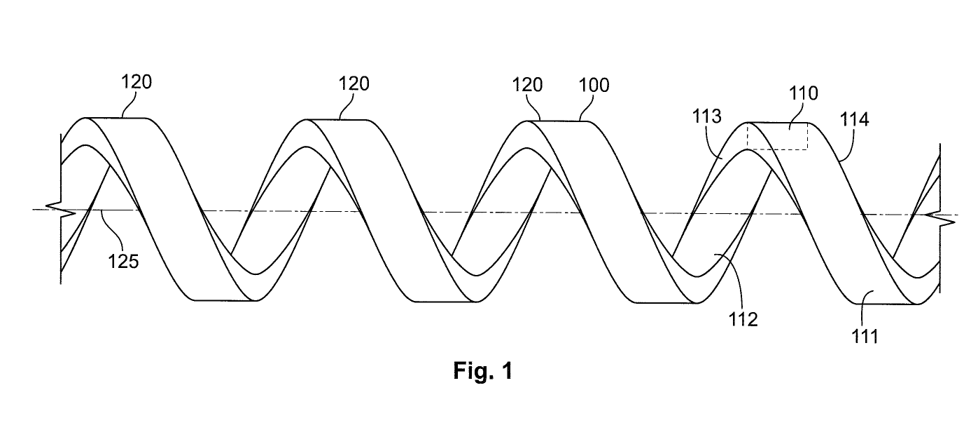

With reference to FIG. 1, a first strand 100 of a tubular member according to the invention is shown. The first strand 100 is an elongate strip having a rectangular cross section 110. In alternative embodiments, the cross section 110 may include a shape that is different from a rectangular shape.

The first strand 100 includes an outer side 111 and an inner side 112 opposite the outer side 111. The first strand 100 further includes a first side 113 and a second side 114 positioned opposite the first side 113.

The first strand 100 is arranged in helical windings 120. The first strand 100 is wound around a winding axis 125. In the helical windings 120 of the first strand 100, the outer side 111 faces outwards away from the winding axis 125. The inner side 112 faces inwards towards the winding axis 125.

The first side 113 of one helical winding 120 of the first strand 100 faces towards the second side 114 of a consecutive helical winding 120 of the first strand 100. In the depiction of FIG. 1, the first sides 113 of the helical windings 120 are spaced from the second sides 114 of the neighboring helical windings 120 of the first strand 100 for illustrative reasons. The first sides 113 may however be bonded to second sides 114 of consecutive helical windings 120 of the first strand 100 to form a tubular member that extends along the winding axis 125. The tubular member is then composed of the first strand 100. The bond connection between the first side 113 and the second side 114 is preferably an integral connection.

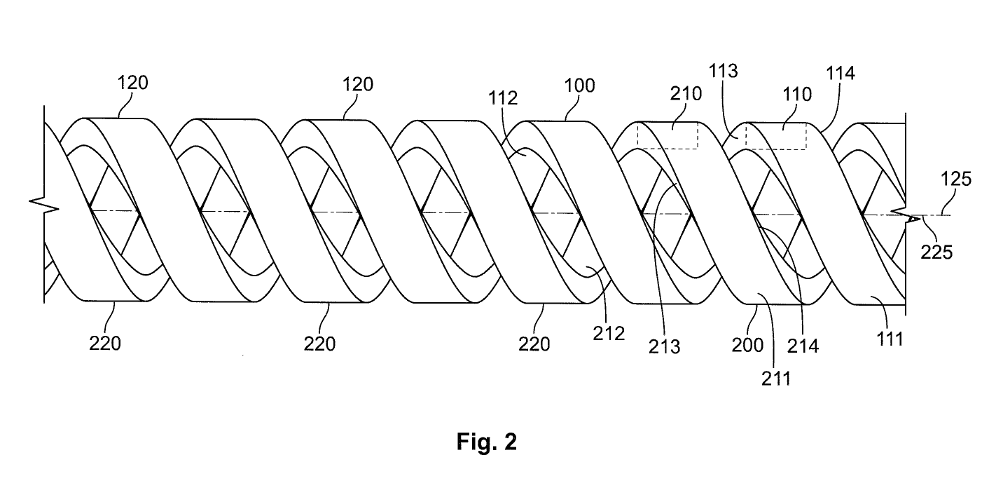

As shown in FIG. 2, the first strand 100 and a second strand 200 for a tubular member according to the invention is shown. The first strand 100 is arranged in helical windings 120 along the winding axis 125, as depicted in FIG. 1.

The second strand 200 includes an elongate strip with a rectangular cross section 210. The cross section 210 may for example be similar or equal to the cross section 110 of the first strand 100. The second strand 200 is arranged in helical windings 220 along a winding axis 225 that coincides with the winding axis 125 of the first strand 100. The second strand 200 includes an outer side 211 and an opposed inner side 212. The outer side 211 faces away from the winding axis 225. The inner side 212 faces towards the winding axis 225. The second strand 200 further includes a first outer surface 213 and an opposed second outer surface 214.

The helical windings 220 of the second strand 200 and the helical windings 120 of the first strand 100 are arranged in an alternating manner. The first side 113 of each helical winding 120 of the first strand 100 faces a second outer surface 214 of a helical winding 220 of the second strand 200. The second side 114 of each helical winding 120 of the first strand 100 faces a first outer surface 213 of a helical winding 220 of the second strand 200.

The sides 113, 114 of the first strand 100 and outer surfaces 213, 214 of the second strand 200 are depicted in a spaced manner in FIG. 2 for illustrative reasons. The sides 113, 114 and outer surfaces 213, 214 of consecutive helical windings 120, 220 of the first strand 100 and the second strand 200 may however be bonded to each other to form a tubular member composed of the first strand 100 and the second strand 200.

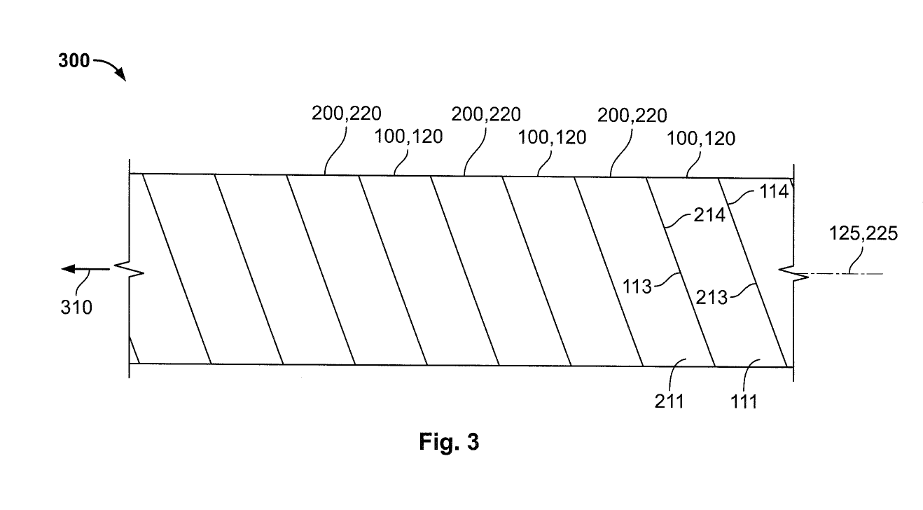

With reference to FIG. 3, a tubular member 300 according to the invention is shown and includes the first strand 100 and the second strand 200. Consecutive helical windings 120 of the first strand 100 and helical windings 220 of the second strand 200 form the tubular member 300. A longitudinal direction 310 of the tubular member 300 coincides with the winding axis 125 of the helical winding 120 of the first strand 100 and the winding axis 225 of the helical windings 220 of the second strand 200. The first side 113 of the first strand 100 is bonded to the second outer surface 214 of the second strand 200 in all helical windings 120, 220. The second side 114 of the first strand 100 is bonded to the first outer surface 213 of the second strand 200 in all helical windings 120, 220 of the first strand 100 and the second strand 200.

The tubular member 300 may serve as a holdout. The tubular member 300 may be disintegrated along the longitudinal direction 310 by gradually unwinding the tubular member 300 that forms a weak line of the tubular member 300.

The weak line of the tubular member 300 may be formed by the bonding connection between the first side 113 of the first strand 100 and the second outer surface 214 of the second strand 200 and/or by the bonding connection between the second side 114 of the first strand 100 and the first outer surface 213 of the second strand 200 or by both bonding connections.

Alternatively, the weak line of the tubular member 300 may be formed by either the first strand 100 or the second strand 200. In this embodiment, the first strand 100 or the second strand 200 breaks along the helical windings 120, 220 while unwinding the tubular member 300. This may be achieved by forming the strands 100, 200 that serves as a weak line from a material that is more brittle or less tear resistant or has less tensile strength than the material of the other strands 200, 100. The more brittle material may for example include a high amount of fillers. It is also possible that both the material the first strand 100 and the material of the second strand 200 are brittle. Both the material of the first strand 100 and the material of the second strand 200 may include a polymeric material. The material of the first strand 100 and the material of the second strand 200 may include a similar polymer base.

The first strand 100 and the second strand 200 may also include of materials that differ in other properties than brittleness. For example, either the material of the first strand 100 or the material of the second strand 200 may be thermally or electrically more conductive than the other material. Either the material of the first strand 100 or the material of the second strand 200 may include other members like metal wires, e.g. for heating purposes. The material of the first strand 100 and the material of the second strand 200 may include different chemical properties. The material of the first strand 100 and the material of the second strand 200 may include different appearances. The first strand 100 and the second strand 200 may also include different cross sections 110, 210. This may also lead to the fact that bonding is not or not only on the sides 113, 114 and outer surfaces 214, 213 but also in other areas of the strands 100, 200.

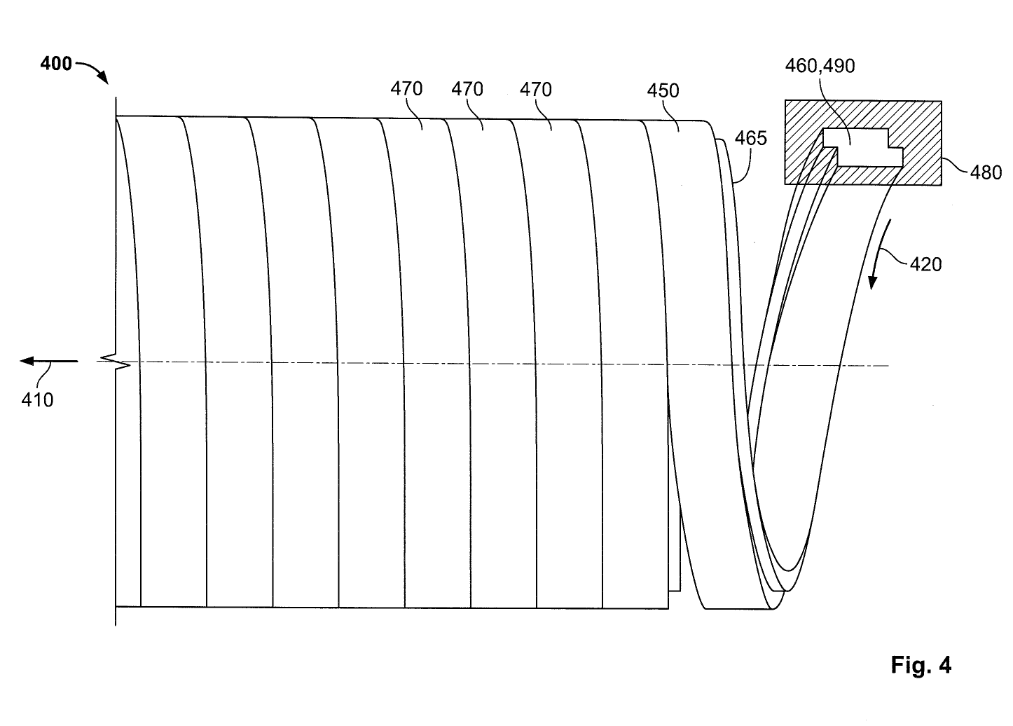

With reference to FIG. 4, an apparatus for producing a tubular member 400 according to the invention is shown. The tubular member 400 consists of one strand 450 that is wound in helical windings 470 around a winding axis that is parallel to a longitudinal direction 410 of the tubular member 400.

The strand 450 is extruded by an extrusion die 480. The extrusion die 480 is arranged such that the strand 450 is extruded in a tangential direction 420 of the tubular member 400. The tangential direction 420 is normal to the longitudinal direction 410.

The extrusion die 480 includes a cross section 490. The strand 450 extruded by the extrusion die 480 consequently includes a cross section 460 that is similar or equal to the cross section 490 of the extrusion die 480. The cross sections 460, 490 do not include a rectangular shape in the example of FIG. 4. The cross section 460 of the strand 450 is rather such that the strand 450 includes a ledge 465. The ledge 465 supports bonding of the sides of the strand 450 together to form the tubular member 400.

After being extruded by the extrusion die 480, the strand 450 is directly bonded to the longitudinal end of the tubular member 400. Consequently, the strand 450 is not spooled on a coiler or stored or processed otherwise between extrusion of the strand 450 and bonding of the strand 450 to form the tubular member 400.

A shown, the strand 450 is bonded to the longitudinal end of the tubular member 400 before the material of the strand 450 has fully crystallized and/or cooled down after extrusion of the strand 450. This supports formation of an integral bond connection between the helical windings 470 of the strand 450 without requiring further treatment of the strand 450 or additional means like e.g. adhesives or additional processes like e.g. ultrasonic or laser welding.

During production of the tubular member 400, the extrusion die 480 rotates around the winding axis of the helical windings 470 relative to the tubular member 400. This may either be achieved by maintaining the tubular member 400 in a fixed position and rotating the extrusion die 480 or by maintaining the extrusion die 480 in a fixed position and rotating the tubular member 400 around the winding axis that coincides with the longitudinal direction 410 of the tubular member 400.

The tubular member 400 of FIG. 4 includes only one strand 450. The tubular member 400 may, however, also be composed of two strands like the tubular member 300 shown in FIG. 3, as will become more apparent in conjunction with the further description below.

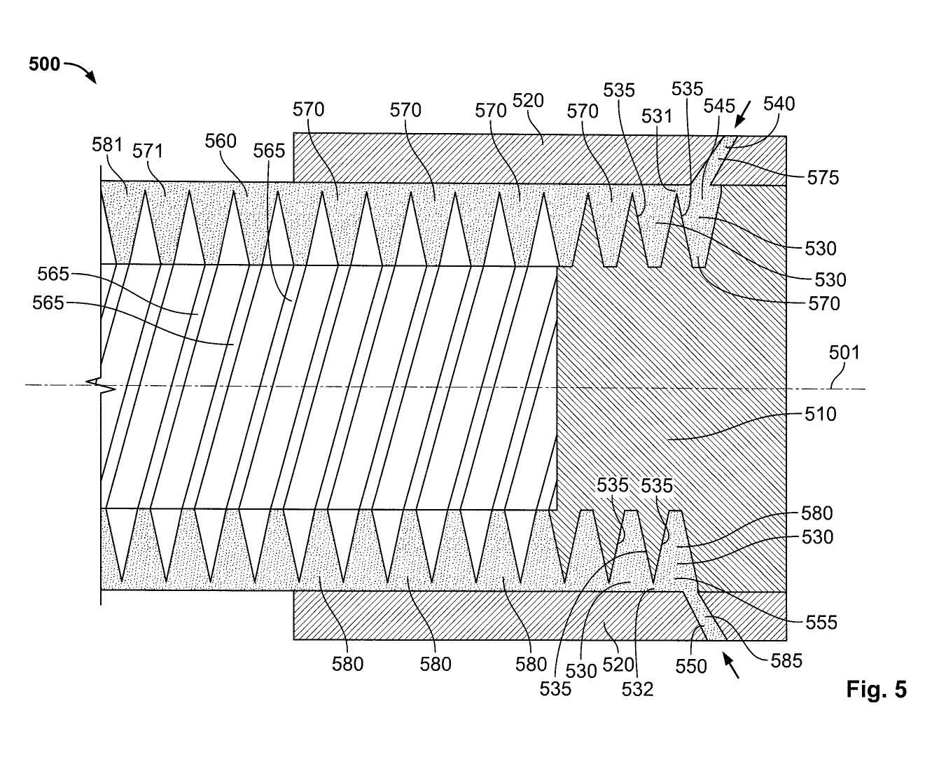

With reference to FIG. 5, a first apparatus 500 for producing a tubular member. The first apparatus 500 according to the invention is shown. The first apparatus 500 includes an inner section 510 and an outer section 520. The inner section 510 and the outer section 520 are substantially rotationally symmetric with respect to an axis 501. The inner section 510 is at least partially arranged inside the outer section 520 with respect to the axis 501.

Arranged between the inner section 510 and the outer section 520 of the first apparatus 500 is an extrusion and bonding chamber 530. The extrusion and bonding chamber 530 is substantially rotationally symmetric with respect to the axis 501. The extrusion and bonding chamber 530 is provided for the extrusion of a first strand 570 and a second strand 580 that together form a tubular member 560.

A first material feed channel 540 extends through the outer section 520 of the first apparatus 500 towards a first extrusion die 545 arranged in the extrusion and bonding chamber 530. The first extrusion die 545 is only shown schematically in FIG. 5. The first extrusion die 545 is arranged tangentially with respect to the tubular member 560. In the example of FIG. 5, the first extrusion die 545 includes an approximately trapezoid cross section.

A second material feed channel 550 is disposed on a side of the outer section 520 that is radially opposed to the first material feed channel 540 with respect to the axis 501, and extends through the outer section 520 of the first apparatus 500 towards a second extrusion die 555 that is arranged in the extrusion and bonding chamber 530 at a position opposed to the first extrusion die 545 with respect to the axis 501. The second extrusion die 555 is also arranged tangentially to the tubular member 560 and includes a cross section that corresponds to the cross section of the first extrusion die 541 in the example of FIG. 5.

A first material 575 is fed through the first material feed channel 540 to form the first strand 570 that is extruded by the first extrusion die 545. The first strand 570 includes a first cross section 571 that corresponds to the cross section of the first extrusion die 545. The first strand 570 is extruded into the extrusion bonding chamber 530 in a tangential direction of the tubular member 560.

A second material 585 is fed through the second material feed channel 550 to form the second strand 580 that is extruded by the second extrusion die 555 into the extrusion and bonding chamber 530 in a tangential direction of the tubular member 560. The second strand 580 includes a second cross section 581 that corresponds to the cross section of the second extrusion die 555.

The second material 585 is preferably different from the first material 575. The first material 575 and the second material 585 may however also be the same material.

The tangential extrusion of the first strand 570 and the second strand 580 in the same rotational direction with respect to the axis 501 exerts a rotational force on the tubular member 560 with respect to the axis 501. The inner section 510 of the first apparatus 500 includes a thread 535 in the region of the extrusion and bonding chamber 530. The thread 535 includes a twofold pitch. The rotational force exerted on the tubular member 560 sets the tubular member 560 in rotation around the axis 501. The thread 535 drives the rotating tubular member 560 out of the extrusion and bonding chamber 530 along the axis 501.

At the same time, the continuously extruded first strand 570 and second strand 580 are continuously bonded to the longitudinal end of the tubular member 560 arranged in the extrusion and bonding chamber 530. The first strand 570 is bonded onto a longitudinal end of the tubular member 560 in a first bonding area 531. The second strand 580 is bonded onto a longitudinal end of the tubular member 560 in a second bonding area 532. The twofold pitch of the thread 535 ensures the formation of alternating helical windings 565, as previously depicted in FIG. 3.

In order to support the rotational movement of the tubular member 560 with respect to the fixed inner section 510, outer section 520, first extrusion die 545 and second extrusion die 555 of the first apparatus 500, a sufficient lubrication between the tubular member 560 and the inner section 510 and the outer section 520 respectively may be required.

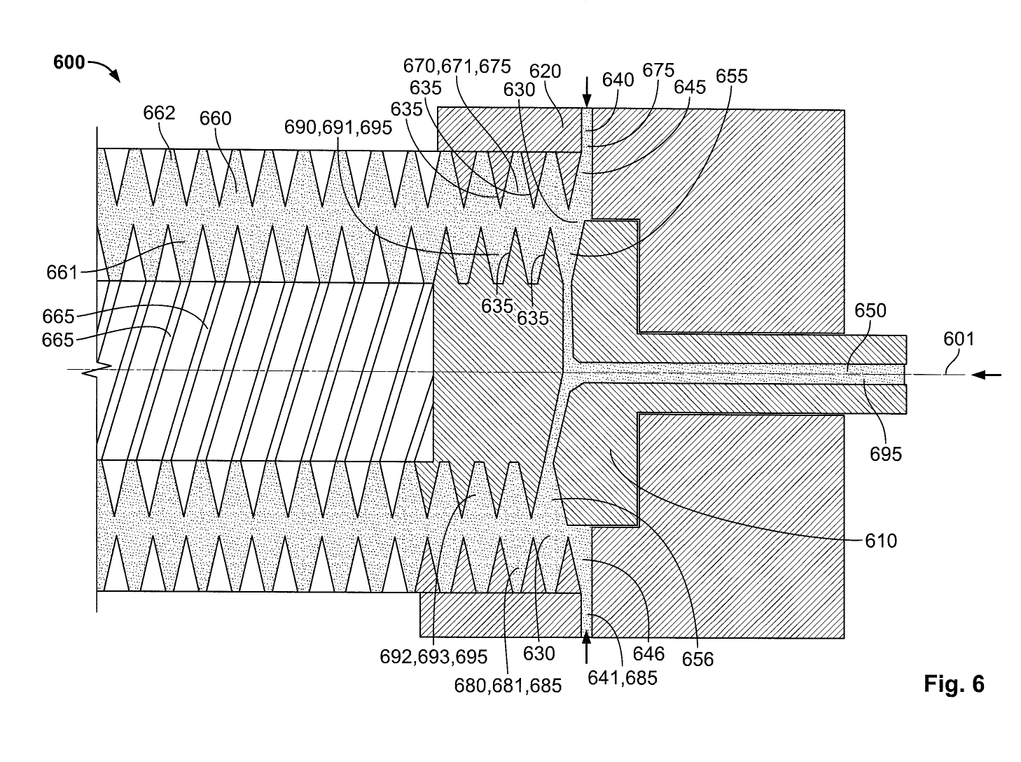

With reference to FIG. 6, a second apparatus 600 for producing a tubular member according to the invention is shown. The second apparatus 600 includes an inner section 610 and an outer section 620. The inner section 610 and the outer section 620 are essentially rotationally symmetric with respect to a common axis 601. The outer section 620 is partially arranged around the inner section 610. In a region between the inner section 610 and the outer section 620 an extrusion and bonding chamber 630 is arranged. Both the inner section 610 and the outer section 620 include a thread 635 in the region of the extrusion and bonding chamber 630.

A first material feed channel 640 extends through the outer section 620 towards a first extrusion die 645 arranged tangentially to a tubular member 660 in the extrusion and bonding chamber 630. A second material feed channel 641 extends through the outer section 620 of the second apparatus 600 towards a second extrusion die 646 arranged tangentially to the tubular member 660 in the extrusion and bonding chamber 630. The first extrusion die 645 and the second extrusion die 646 are arranged at opposed positions of the extrusion and bonding chamber 630 with respect to the common axis 601. The first extrusion die 645 and the second extrusion die 646 are arranged in the same rotational direction with respect to the common axis 601.

A third material feed channel 650 extends through the inner section 610 of the second apparatus 600 towards a third extrusion die 655 and a fourth extrusion die 656. Both the third extrusion die 655 and the fourth extrusion die 656 are arranged in a tangential direction of the tubular member 660 in the extrusion and bonding chamber 630. The third extrusion die 655 and the fourth extrusion die 656 are opposed to each other with respect to the common axis 601. The third extrusion die 655 is arranged at the same angular position of the extrusion and bonding chamber 630 as the first extrusion die 645. The fourth extrusion die 656 is arranged at the same angular position of the extrusion and bonding chamber 630 as the second extrusion die 646. All extrusion dies 645, 646, 655, 656 are oriented in the same angular direction with respect to the common axis 601.

A first strand 670 with a first cross section 671 and composed of the first material 675 is extruded by the first extrusion die 645. The second strand 680 includes a second cross section 681 and a second material 685 is extruded by the second extrusion die 646. A third strand 690 includes a third cross section 691 and a third material 695 is extruded by the third extrusion die 655. A fourth strand 692 includes a fourth cross section 693 and the third material 695 is extruded by the fourth extrusion die 656. The first material 675 and the second material 685 may be the same material in a simplified embodiment. In the example shown in FIG. 6, all cross sections 671, 681, 691, 693 include an approximately trapezoidal shape.

The first strand 670 and the second strand 680 are bonded together to form alternating helical windings 665 of an outer tube 662 of the tubular member 660. The third strand 690 and the fourth strand 692 are bonded together to form alternating helical windings 665 of an inner tube 661 of the tubular member 660. At the same time, the inner tube 661 and the outer tube 662 of the tubular member 660 are bonded together in the extrusion and bonding chamber 630.

Extrusion of the strands 670, 680, 690, 692 exerts a rotational force on the tubular member 660 that sets the tubular member 660 in rotational movement around the common axis 601 with respect to the inner section 610 and the outer section 620 of the second apparatus 600. The thread 635 ensures that the rotational movement of the tubular member 660 is attended by a longitudinal movement in a longitudinal direction of the tubular member 660 that coincides with the common axis 601. The longitudinal movement of the tubular member 660 moves the tubular member 660 out of the extrusion and bonding chamber 630.

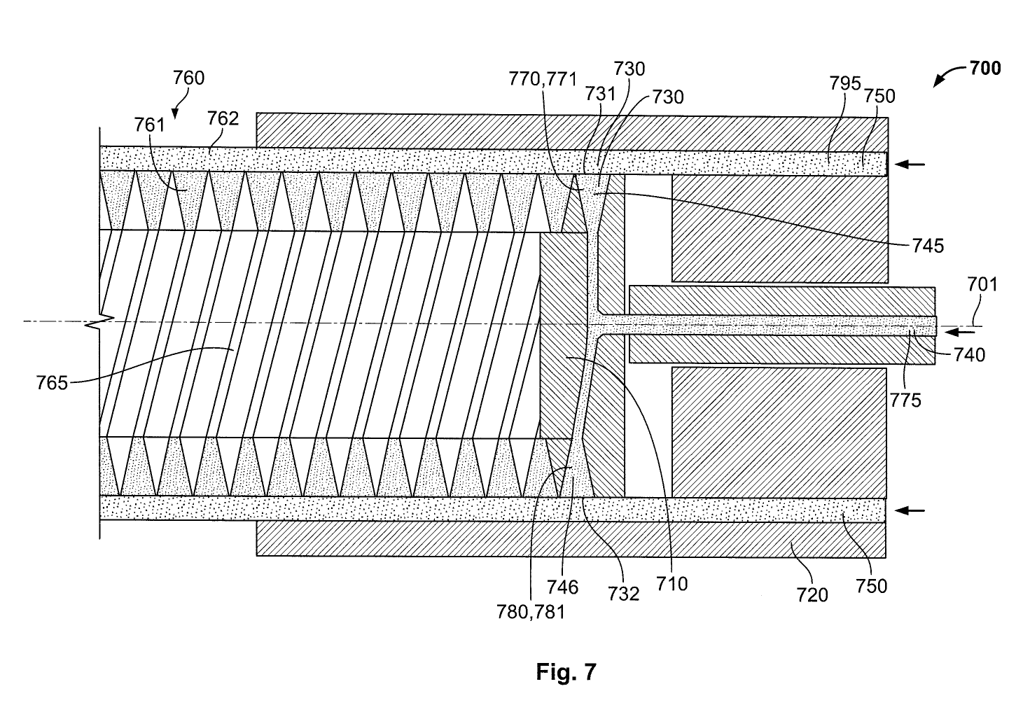

With reference to FIG. 7, a third apparatus 700 for producing a tubular member according to the invention is shown. The third apparatus 700 includes an inner section 710 and an outer section 720. Both the inner section 710 and outer section 720 are approximately rotationally symmetric with respect to an axis 701. An approximately rotationally symmetric co-extrusion and bonding chamber 730 is arranged between the inner section 710 and the outer section 720 of the third apparatus 700.

The inner section 710 includes a first extrusion die 745 and a second extrusion die 746. The first extrusion die 745 and the second extrusion die 746 are arranged tangentially to a tubular member 760 at opposed positions of the co-extrusion and bonding chamber 730. The first material feed channel 740 extends through the inner section 710 to feed a first material 775 to the first extrusion die 745 and the second extrusion die 746.

The first extrusion die 745 serves to extrude a first strand 770 that includes a first cross section 771 and the first material 775. The second extrusion die 746 serves to extrude a second strand 780 that includes a second cross section 781 and the first material 775.

The inner section 710 includes the first extrusion die 745 and the second extrusion die 746 rotates around the axis 701 with respect to the outer section 720 of the third apparatus 700 and the tubular member 760. The first strand 770 and the second strand 780 are extruded in a tangential direction of the tubular member 760 in the same rotational direction with respect to the axis 701. The first strand 770 and the second strand 780 can be bonded together in alternating helical windings 765 in the co-extrusion and bonding chamber 730 to form an inner tube 761 of the tubular member 760. Alternatively the first strand 770 and the second strand 780 are not bonded together but are both bonded to the tubular member 760. At the same time, the tubular member 760 is longitudinally moved out of the co-extrusion and bonding chamber 730 along a direction that coincides with the axis 701.

The outer section 720 of the third apparatus 700 includes a second material feed channel 750 that is provided to feed a second material 795 to the co-extrusion and bonding chamber 730. In the co-extrusion and bonding chamber 730, the second material 795 is co-extruded with the first strand 770 in a first bonding area 731 and the second strand 780 in a second bonding area 732 to form an outer tube 762 that arranged on an outer side of the inner tube 761. The inner tube 761 and the outer tube 762 together form a tubular member 760.

Alternatively, the first strand 770 and the second strand 780 are not bonded together, but only bonded to the outer tube 762.

Extrusion of the outer tube 762 in the longitudinal direction of the tubular member 760 drives the tubular member 760 out of the co-extrusion and bonding chamber 730 in the longitudinal direction of the tubular member 760. The rotating first extrusion die 745 and second extrusion die 746 continuously arrange further helical windings 765 of the first strand 770 and the second strand 780 respectively on the freshly extruded outer tube 762.

The co-extruded inner tube 761 and outer tube 762 of the tubular member 760 may serve to fulfill different purposes. The inner tube 761 of the tubular member 760 may serve as a holdout. The outer tube 762 of the tubular member 760 may serve as a shrinkable member. The second material 795 of the outer tube 762 may be an elastomeric material or another material, e.g. a cold shrinkable material, a heat shrinkable material or a combination of cold shrinkable and heat shrinkable materials.

The inner tube 761 and the outer tube 762 of the tubular member 760 may be pre-expanded together after co-extrusion of the tubular member 760. The inner tube 761 and the outer tube 762 of the tubular member 760 may for example be pre-expanded by a factor of up to 300%.

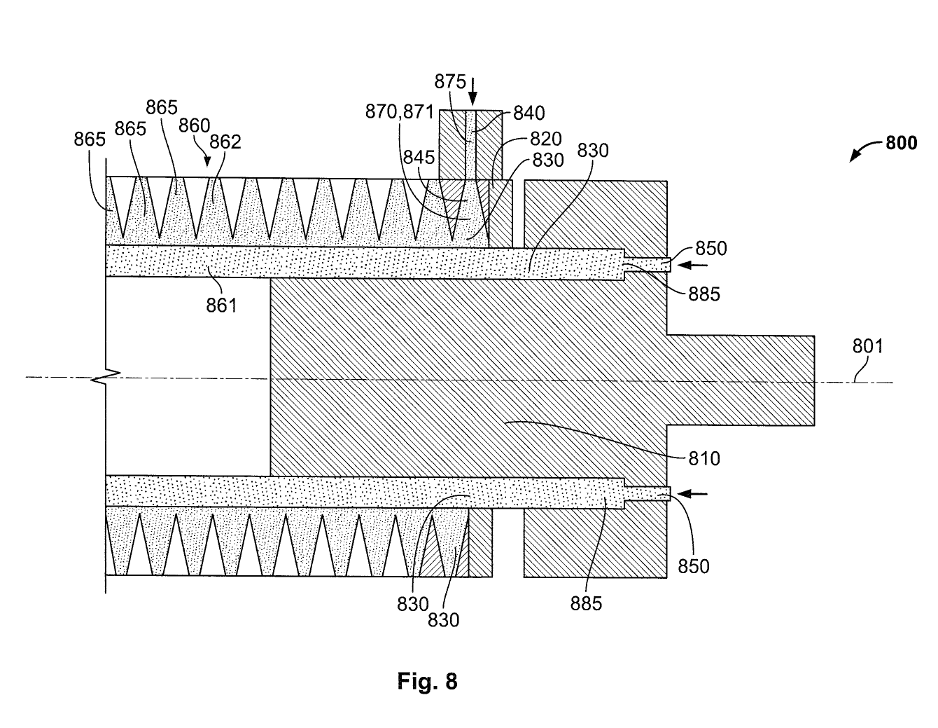

With reference to FIG. 8, a fourth apparatus 800 for producing a tubular member according to the invention is shown. The fourth apparatus 800 includes an inner section 810 and an outer section 820. The inner section 810 and the outer section 820 both are essentially rotationally symmetric with respect to an axis 801. A co-extrusion and bonding chamber 830 is arranged in a region between the inner section 810 and the outer section 820 of the fourth apparatus 800.

The outer section 820 includes an extrusion die 845 that is arranged tangentially with respect to a tubular member 860 in the co-extrusion and bonding chamber 830. A first material feed channel 840 extends through the outer section 820 to feed a first material 875 to the extrusion die 845 to extrude a strand 870 with a cross section 871. In the example of FIG. 8, the cross section 871 includes an approximately trapezoidal shape. The cross section 871 of the strand 870 may, however, include a different shape.

The inner section 810 of the fourth apparatus 800 includes a second material feed channel 840 for feeding a second material 885 to the co-extrusion and bonding chamber 830. In the co-extrusion and bonding chamber 830, a tubular inner tube 861 is formed from the second material 885.

The outer section 820 includes the extrusion die 845 that rotates around the axis 801 with respect to inner section 810 and the inner tube 861 is formed in the co-extrusion and bonding chamber 830. The rotating outer section 820 arranges the strand 870 extruded by the extrusion die 845 in helical windings 865 around the inner tube 861, to form an outer tube 862. The inner tube 861 and the outer tube 862 together form the tubular member 860.

The inner tube 861 of the tubular member 860 may serve as a shrinkable member. The outer tube 862 of the tubular member 860 may serve as an external holdout for the shrinkable inner tube 861. The tubular member 860 includes the inner tube 861 and the outer tube 862 may be pre-expanded by a factor of for example up to 300% after co-extrusion of the tubular member 860.

The outer tube 862 may bond well to the inner tube 861. Further the windings 865 of the outer tube 862 may or may not bond to each other but allow for tearing apart.

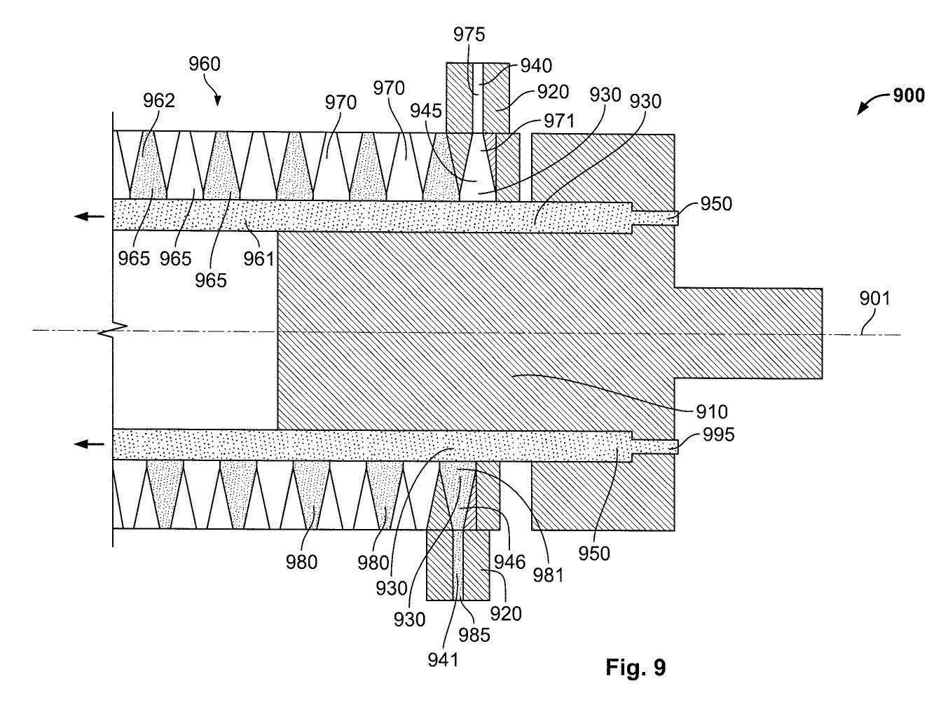

With reference to FIG. 9, a fifth apparatus 900 for producing a tubular member according to the invention is shown. The fifth apparatus 900 includes an inner section 910 and an outer section 920. Both the inner section 910 and the outer section 920 are essentially rotationally symmetric with respect to an axis 901. Arranged in a ring shaped-region between the inner section 910 and the outer section 920 is a co-extrusion and bonding chamber 930.

The inner section 910 includes a third fee pipe 950 for feeding a third material 995 to the co-extrusion and bonding chamber 930. The third material 995 is extruded in the co-extrusion and bonding chamber 930 to form a tubular inner tube 961 of a tubular member 960. Continuous extrusion of the inner tube 961 drives the produced tubular member 960 continuously out of the co-extrusion and bonding chamber 930 in a longitudinal direction of the tubular member 960 that coincides with the axis 901.

The outer section 920 of the fifth apparatus 900 includes a first extrusion die 945 and second extrusion die 946. Both extrusion dies 945, 946 are oriented in a tangential direction of the tubular member 960 in the co-extrusion and bonding chamber 930. The first extrusion die 945 and the second extrusion die 946 are arranged at opposed positions of the co-extrusion and bonding chamber 930 with respect to the axis 901.

A first material feed channel 940 extends through the outer section 920 of the fifth apparatus 900 to feed a first material 975 to the first extrusion die 945. A second material feed channel 941 extends through the outer section 920 to feed a second material 985 to the second extrusion die 946.

The outer section 920 rotates around the axis 901 with respect to the inner section 910 and the inner tube 961 of the tubular member 960. The first extrusion die 945, rotating around the axis 901, continuously extrudes a first strand 970 includes a first cross section 971 and the first material 975 and arranges the first strand 970 continuously around the inner tube 961 of the tubular member 960, bonding the first strand 970 to the inner tube 961. At the same time, the second extrusion die 946, rotating around the axis 901, extrudes a second strand 980 includes a second cross section 981 and the second material 985 and arranges the second strand 980 around the inner tube 961 of the tubular member 960, bonding the second strand 980 to the inner tube 961 and possibly also to the first strand 970. In interplay between the longitudinal movement of the inner tube 961 and the rotational movement of the extrusion dies 945, 946, the first strand 970 and the second strand 980 are arranged in alternating helical windings 965 around the inner tube 961 to form an outer tube 962 of the tubular member 960.

The first material 975 of the first strand 970 and the second material 985 of the second strand 980 may be the same material or different materials.

The inner tube 961 of the tubular member 960 may serve as a shrinkable member. The third material 995 of the inner tube 961 of the tubular member 960 may for example be an elastomeric material or another material, e.g. a cold shrinkable material, a heat shrinkable material or a combination of cold shrinkable and heat shrinkable materials. The outer tube 962 of the tubular member 960 may serve as an external holdout. The inner tube 961 and the outer tube 962 of the tubular member 960 may be pre-expanded by a factor of for example up to 300% after co-extrusion of the inner tube 961 and the outer tube 962 of the tubular member 960.

Since the outer tube 962 of the tubular member 960 is composed of alternating helical windings 965 of the first strand 970 and the second strand 980, weak lines of the outer tube 962 may be arranged in the bonding areas between the first strand 970 and the second strand 980, or inside the first strand 970 or inside the second strand 980.

The outer tube 762 of the tubular member 760 of FIG. 7, the inner tube 861 of the tubular member 860 of FIG. 8 and the inner tube 961 of the tubular member 960 of FIG. 9 may include one or more materials that may be arranged concentric and that do not necessarily need to be continuous in the longitudinal directions of the tubular members 760, 860, 960. The two or more materials may be cold shrinkable, heat shrinkable or a combination of those.

The strands 100, 200, 450, 570, 580, 670, 680, 690, 692, 770, 780, 870, 970, 980 of the tubular members 300, 400, 560, 660, 760, 860, 960 of FIGS. 1 to 9 have been shown with cross sections 110, 210, 460, 571, 581, 671, 681, 691, 693, 771, 781, 871, 971, 981 that include of only one material. It is however possible, that each cross section surface includes of two or more materials. This may support creation of a weak line that is arranged inside a strand forming a tubular member. A strand forming a tubular member may also include a cross section that includes trenches or cuts. This may also support the formation of a weak line inside the strand.

With reference to FIG. 10, a first strand profile 1000 is shown. The first strand profile 1000 includes an outer side 1001 and an inner side 1002 that is opposed to the outer side 1001. The strand profile 1000 further includes a first side 1003 and a second side 1004 that is opposed to the first side 1003. If the strand is arranged in helical windings to form a tubular member, the first side 1003 is bonded to the second side 1004.

The first strand profile 1000 includes an outer trench 1010 that extends from the outer side 1001 to an inner region of the first strand profile 1000. The first strand profile 1000 further includes an inner trench 1020 that extends from the inner side 1002 towards an inner region of the first strand profile 1000. The outer trench 1010 and the inner trench 1020 are inclined with respect to the outer side 1001 and the inner side 1002. The outer trench 1010 and the inner trench 1020 are designed as essentially parallel trenches. A section between the outer trench 1010 and the inner trench 1020 may serve as a weak line of the strand includes the first strand profile 1000. The strand includes the first strand profile 1000 may break in the region between the outer strand 1010 and the inner trench 1020 while unwinding a tubular member formed by the strand arranged in helical winding.

A strand includes the first strand profile 1000 may be extruded using an extrusion die with a cross section that essentially corresponds to a negative of the first strand profile 1000.

With reference to FIGS. 11 to 15, other possible strand profiles are shown. Each of these strand profiles includes an inner trench and/or an outer trench. The strand profiles may be extruded using appropriately shaped extrusion dies.

With reference to FIG. 11, a second strand profile 1200 is shown and includes only an inner trench 1220. The inner trench 1220 extends from the inner side 1002 of the second strand profile 1200 towards the outer side 1001. Between the inner trench 1220 and the outer side 1001, a strand includes the second strand profile 1200 includes a reduced material thickness. Consequently, a weak line of a strand includes the second strand profile 1200 is formed in the region between the inner trench 1220 and the outer side 1001.

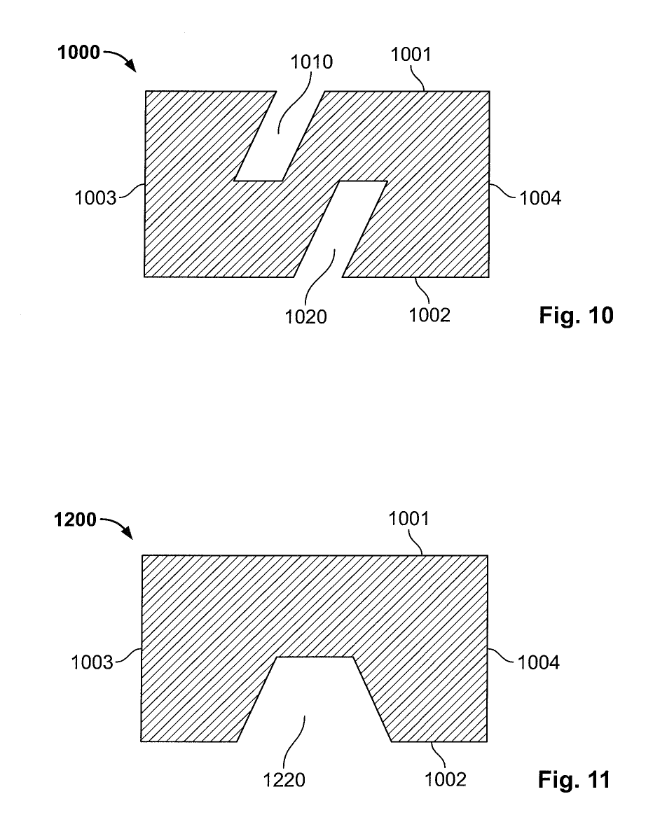

With reference to FIG. 12, a third strand profile 1300 is shown. The third strand profile 1300 includes an outer trench 1310 and an inner trench 1320. Again, a weak line is formed in an area between the outer trench 1310 and the inner trench 1320.

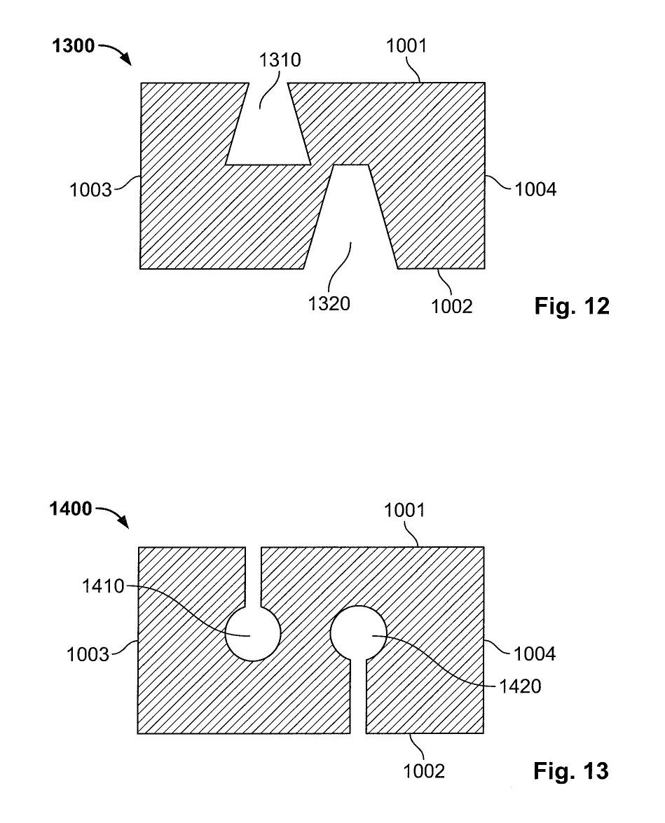

With reference to FIG. 13, a fourth strand profile 1400 is shown. The fourth strand profile 1400 includes an outer trench 1410 and an inner trench 1420. Both the outer trench 1410 and the inner trench 1420 include an undercut. A weak line is formed between the outer trench 1410 and the inner trench 1420. The outer trench 1410 includes an undercut that can advantageously be fabricated using an extrusion production method. Such undercut cannot be produced easily by extruding a substantially tubular sleeve and then removing material by mechanical treatment, e.g. on a lathe.

With reference to FIG. 14, a fifth strand profile 1600 is shown. The fifth strand profile 160 includes an outer trench 1610. The fifth strand profile 1600 includes a reduced material thickness in an area between the outer trench 1610 and the inner side 1002. This area of reduced material thickness forms a weak line of the strand includes the fifth strand profile 1600.

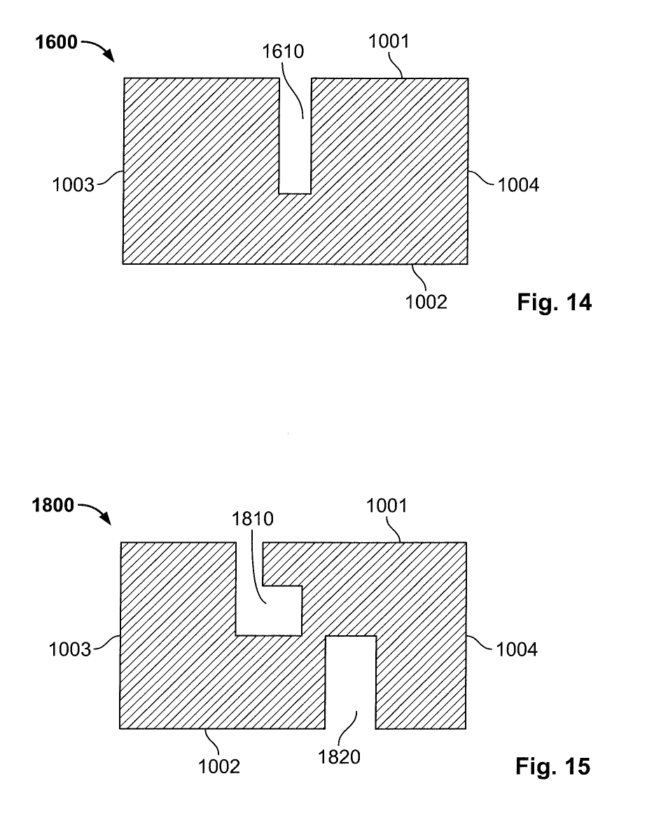

With reference to FIG. 15, a sixth strand profile 1800 is shown. The sixth strand profile 1800 includes an outer trench 1810 and an inner trench 1820. The outer trench 1810 includes an undercut. A region between the outer trench 1810 and the inner trench 1820 forms a weak line.

In alternative embodiments, the trenches 1010, 1020, 1220, 1310, 1320, 1410, 1420, 1610, 1810, 1820 of strands includes the strand profiles 1000, 1200, 1300, 1400, 1600, 1800 may be filled with a second material. Two materials are co-extruded side-by-side such that the strand is formed of a first material and the trenches 1010, 1020, 1220, 1310, 1320, 1410, 1420, 1610, 1810, 1820 are filled with the second material. The second material may for example be more brittle than the first material.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims

What is claimed is:

1. A method for producing a tubular member, comprising the steps of:
extruding a first strand having a first side and a second side with an extrusion die;
arranging the first strand into a plurality of helical windings; and
bonding the first side and the second side.

2. The method according to claim 1, wherein the first strand is bonded through crystallization.

3. The method according to claim 2, wherein the first strand is extruded in a tangential direction relative to a length of the tubular member.

4. The method according to claim 3, further comprising the step of:
extruding a second strand having a first outer surface and a second outer surface simultaneously with the first strand.

5. The method according to claim 4, wherein the first strand and the second strand include different materials.

6. The method according to claim 1, further comprising the step of co-extruding a layer of material concentrically to the first strand.

7. The method according to claim 6, wherein the layer of material is co-extruded to an outer surface of the first strand.

8. The method according to claim 6, wherein the layer of material is co-extruded to an inner side of the first strand.

9. The method according to claim 8, further comprising the step of radially expanding the first strand and the layer of material.

10. A tubular member, comprising:
a first strand arranged in a first helical winding and having an extruded first material; and
a second strand having an extruded second material and arranged in a second helical winding adjacent to the first strand forming an outer tube.

11. The tubular member according to claim 10, further comprising an inner tube disposed along an inner surface of the outer tube.

12. The tubular member according to claim 11, wherein the inner tube is an elastomeric member, a cold shrinkable member, a heat shrinkable member, or a combination of cold shrinkable and heat shrinkable members disposed on an outer surface of the outer tube.

13. The tubular member according to claim 10, further comprising an elastomeric member, a cold shrinkable member, a heat shrinkable member, or a combination of cold shrinkable and heat shrinkable members disposed on an outer surface of the outer tube.

14. The tubular member according to claim 10, wherein the first helical winding and the second helical winding are arranged in an alternating helical arrangement extending a length of the tubular member.

15. The tubular member according to claim 14, wherein the extruded first material is more brittle or less tear resistant or has less tensile strength than the extruded second material.

16. An apparatus for producing a tubular member, comprising:
a first extrusion die for extruding a strand of first material into a helical winding; and
a ledge bonding the helical winding.

17. The apparatus according to claim 16, wherein the strand of material rotates about the first extrusion die.

18. The apparatus claim 17, further comprising a second extrusion die simultaneously extruding a second strand of material into another helical winding positioned adjacent to the helical winding of the strand of first material.

19. The apparatus claim 17, wherein the strand of material includes a trench.

20. The apparatus claim 19, further comprising a second material extruded into the trench.
